(19) United States
(12) Patent Application Publication
(10) Pub. No.: US 2011/0223087 A1
(43) Pub. Date: Sep. 15, 2011

(54) AMINO COMPOUNDS FOR CARBON DIOXIDE AND SULFUR DIOXIDE REMOVAL

(75) Inventors: Steven Raymond Lustig, Landenberg, PA (US); Dennis A. Redder, Hockessin, DE (US)

(73) Assignee: E. I. DU PONT DE NEMOURS AND COMPANY, Wilmington, DE (US)

(21) Appl. No.: 13/045,911

(22) Filed: Mar. 11, 2011

Related U.S. Application Data
(60) Provisional application No. 61/416,421, filed on Nov. 23, 2010.
(60) Provisional application No. 61/414,532, filed on Nov. 17, 2010.
(60) Provisional application No. 61/313,298, filed on Mar. 12, 2010.

(51) Int. Cl. B01D 53/62; B01D 53/50

(52) U.S. Cl. 423/228; 423/242.7; 423/242.6

(57) ABSTRACT

Described are amino compounds that are useful to methods of carbon dioxide removal.

This application claims priority under 35 U.S.C. §119(e) from, and claims the benefit of, U.S. Provisional Application No. 61/313,298, filed Mar. 12, 2010; U.S. Provisional Application No. 61/414,532, filed Nov. 17, 2010; and U.S. Provisional Application No. 61/416,421, filed Nov. 23, 2010; each of which is by this reference incorporated in its entirety as a part hereof for all purposes.

### TECHNICAL FIELD

This invention relates to amino compounds, and compositions thereof, that are useful to methods of carbon dioxide and/or sulfur dioxide capture and removal.

### BACKGROUND

There is increasing interest in methods to reduce or capture CO₂ from many different gaseous mixtures. CO₂ is an undesired component that is present in many gas streams such as natural gas and effluent gases, and there is also much global interest in reducing CO₂ emissions from combustion exhaust for the prevention of global warming. CO₂ can be removed or captured by many means, such as physical or chemical absorption of the gas by a liquid or solid.

Currently, a common method of carbon dioxide capture from process streams in industrial complexes involves the use of aqueous solutions of alkanolamines, but usually on a small scale. The process has been used commercially since the early 1930s (see, for example, Kohl and Nielsen, Gas Purification, 5th Edition, Gulf Publishing, Houston Tex., 1997), and is based on the reaction of a weak base (alkanolamine) with a weak acid (CO₂) to produce a water-soluble salt. This reaction is reversible, and the equilibrium is temperature dependent.

The use of alkanolamines as absorbents for CO₂ (from power plant flue gases, for example) is somewhat disadvantaged in respect of the amount of energy needed to regenerate the CO₂-rich solvent, the size of the CO₂ capture plant, and the loss of alkanolamines to the environment. Among conventional alkanolamines, monoethanolamine (MEA) is considered an attractive solvent at low partial pressures of CO₂ because it reacts at a rapid rate and the cost of the raw materials is low. The costs of absorption processes using MEA are high, however, because of the high energy consumption in regeneration, and because of operation problems such as corrosion, solvent loss and solvent degradation. Physical absorption systems have advantages over chemical absorption such as lower energy costs, but also have disadvantages such as solvent losses and low CO₂ capacity.

A need thus remains for systems and materials capable of providing low-cost, high-capacity methods of CO₂ capture. Concurrently, there is also interest in methods to reduce or capture SO₂ from many different gaseous mixtures. Ideally the same process and compounds could be used for both gases, with the capability to selectively release the gases upon demand.

### SUMMARY

This invention provides a method for the removal of CO₂ and/or SO₂ from a gaseous mixture by contacting the gaseous mixture with one or more compositions represented by the structure of Formula I, Formula II, Formula III, Formula IV or Formula V:

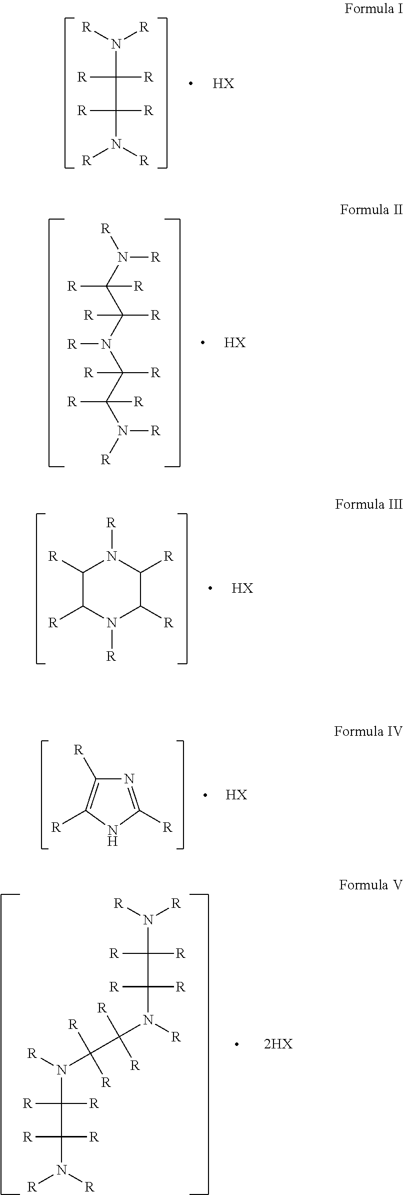

wherein, each R is independently H, alkyl, hydroxyalkyl, aminoalkyl, alkylaminoalkyl or alkoxyalkyl, wherein the alkyl groups contain 1-6 carbons; and each R together can form one or more alicyclic rings with another R; and

HX is an acid with an acidic proton that forms a partially neutralized salt of the amine.

The method optionally involves an additional step of recovering a reaction product (such as a compound, composition or adduct) formed between CO₂ and/or SO₂ and a Formulae I˜V composition; and also involves yet another optional step of separating CO₂ and/or SO₂ from the Formulae I˜V composition, and recovering either or both of CO₂ and/or SO₂ and the Formulae I˜V composition. Separation can be effected by heating or the use of a non-solvent. CO₂ and/or SO₂ can thereby be removed from the mixture.

### BRIEF DESCRIPTION OF THE DRAWINGS

FIG. 1 shows absorption/desorption of CO₂ in aqueous 1,2-diaminocyclohexane monohydrochloride.

FIG. 2 shows absorption/desorption of CO₂ in aqueous N,N-diethylenediamine monohydrochloride.

### DETAILED DESCRIPTION

In the description of the compositions hereof, the following definitional structure is provided for certain terminology as employed variously in the specification:
An “alkyl” group is a monovalent (i.e. having a valence of one) group represented by the formula CₙH₂ₙ₊₁.
A “hydroxyalkyl” group is a monovalent (i.e. having a valence of one) group represented by the formula HO(CH₂)ₙ.
An “alkoxyalkyl” group is a monovalent (i.e. having a valence of one) group represented by the formula (CₙH₂ₙ₊₁)O(CH₂)ₙ.

An “aminoalkyl” group is a monovalent (i.e. having a valence of one) group represented by the formula H₂N(CH₂)ₙ.

An “alkylaminoalkyl” group is a monovalent (i.e. having a valence of one) group represented by the formula (CH₂)ₙNH(CH₂)ₙ.

In the above formulae, n is a value in the range of 1˜20, 1˜10, 1˜8, 1˜4, 2˜20, 2˜10, 2˜8, 3˜10, 3˜6, 4˜10, or 4˜8. The —-CH₂— portion of any of the above described groups may thus, in various embodiments, be independently methyl, ethyl, propyl, butyl, pentyl, hexyl.

There are provided herein methods for removal of CO₂ and/or SO₂ from a gaseous mixture in which they are contained comprising contacting the gaseous mixture with one or more compositions represented by the structure of Formula I, Formula II, Formula III, Formula IV or Formula V, which compositions constitute a partially neutralized vicinal diamine, triamine or tetramine:

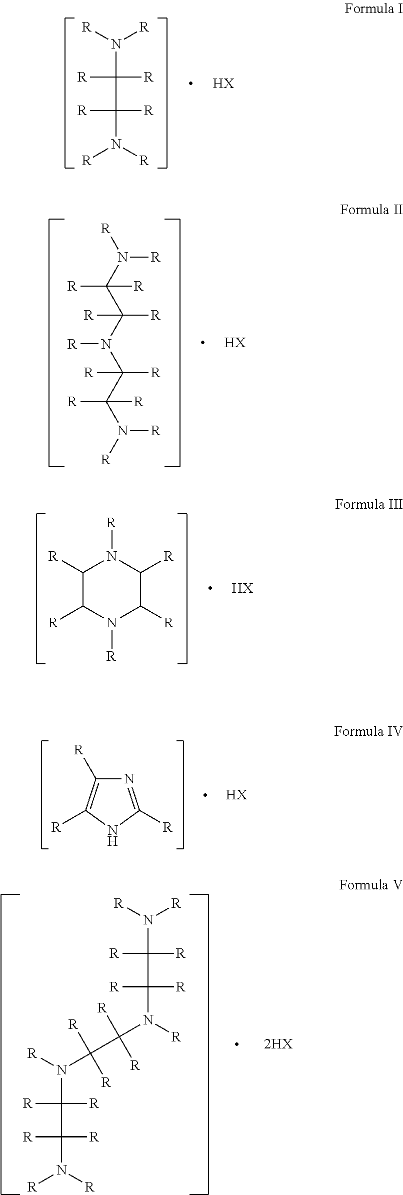

wherein

wherein, each R is independently H, alkyl, hydroxyalkyl, aminoalkyl, alkylaminoalkyl or alkoxyalkyl, wherein the alkyl groups contain 1, 2, 3, 4, 5 or 6 carbons; and each R together can form one or more alicyclic rings with another R; and

HX is an acid with an acidic proton that forms a partially neutralized salt of the amine.

The alkyl portion of any of the above described R groups may thus, in various embodiments, be independently methyl, ethyl, propyl, butyl, pentyl, hexyl.

In one embodiment, alicyclic rings are formed in a Formula I, II or V compound by R groups that are not bonded to a terminal nitrogen; the result of which being that, in one of the embodiments of a Formula I composition, the amine is cyclohexanediamine (1,2-diaminocyclohexane). In another embodiment of a Formula I composition, however, the amine can be an ethylene diamine.

An ethylene diamine can be prepared by treating ethylene dichloride, ethylene oxide or ethanol amine with aqueous or liquid ammonia at about 100 C. in the liquid phase. Diethylenetriamines and triethylenetetraamines are also produced by this reaction. Ethylene diamine can also be prepared by reacting monoethanolamine with ammonia and hydrogen over a nickel or cobalt catalyst at 150-230° C. 1,2-diaminopropanes can be prepared by amminating a mixture of 2-amino-1-propanol and 1-amino-2-propanol.

A mixture of cis- and trans-1,2-diaminocyclohexane is produced by the hydrogenation of o-phenylenediamine. The racemic trans isomer [1:1 mixture of (1R,2R)-1,2-diaminocyclohexane and (1S,2S)-1,2-diaminocyclohexane] can be separated into the two enantiomers using enantiomerically pure tartaric acid as the resolving agent.

In one embodiment of a Formula II composition, the amine is a diethylenetriamine. A diethylenetriamine can be prepared as noted above in the process for making an ethylene diamine, or can be prepared by cyanoethylation of diaminoethane or a diaminopropane with acrylonitrile after which the product is hydrogenated.

In one embodiment of a Formula III composition, the amine is a piperazine such as 1-methylpiperazine. A piperazine is also obtained from the production of ethylene diamine by, for example, reacting ethanolamine with ammonia at 150-220° C., and distilling piperazine from the reaction mixture.

In one embodiment of a Formula IV composition, the amine is an imidazole such as 4,5-diaminomethylimidazole.

An imidazole can be prepared in the Debus synthesis by reacting glyoxal and formaldehyde in ammonia as follows:

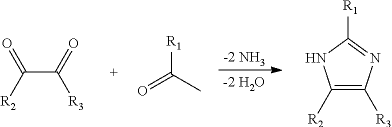

The (1,5) or (3,4) bond can be formed by the reaction of an imidate and an α-aminoaldehyde or α-aminoacetal, resulting in the cyclization of an amidine to imidazole, as shown below. R₁=R as described above, which could for example by hydrogen.

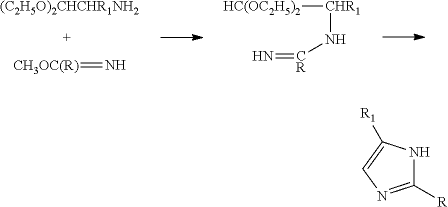

The (1,2) and (2,3) bonds can be formed by treating a 1,2-diaminoalkane, at high temperatures, with an alcohol, aldehyde, or carboxylic acid, as shown below. A dehydrogenating catalyst, such as platinum on alumina, is used. R₁, R₂ and R₃=R as described above.

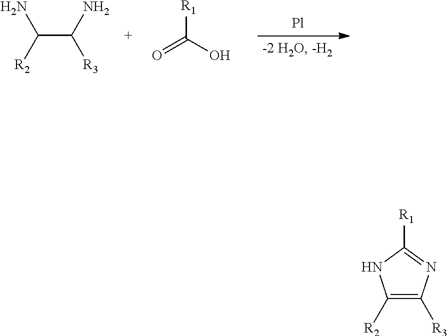

The (1,2) and (3,4) bonds can also be formed from N-substituted α-aminoketones and formamide with heat, as shown below. R₁=hydrogen.

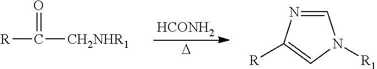

In another method, the starting materials are substituted glyoxal, aldehyde, amine, and ammonia or an ammonium salt, as shown below. R₁, R₂ and R₃=R as described above. R₄=hydrogen.

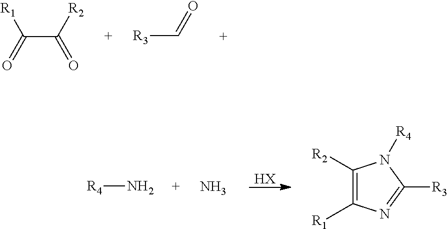

Imidazole can also be synthesized by the photolysis of 1-vinyltetrazole, as shown below, preferably with the use of an organotin compound such as 2-tributylstannyltetrazole. R₁ and R₂=R as described above.

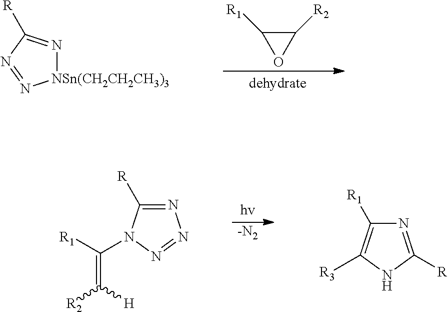

Imidazole can also be formed in a vapor phase reaction that occurs with formamide, ethylenediamine, and hydrogen over platinum on alumina at about 340 to 480° C.

In one embodiment of a Formula V composition, the amine is a triethlyenetetramine such as N,N,N′,N′-tetramethyltriethlyenetetramine. A triethylenetetraamine can be prepared as noted above in the process for making an ethylene diamine, or can be prepared by cyanoethylation of diaminoethane or a diaminopropane with acrylonitrile after which the product is hydrogenated.

In one embodiment, the compounds of Formula I, Formula II, Formula III, Formula IV or Formula V form a salt with HX, where HX is an acid with an acidic proton that forms a partially neutralized diamine, triamine or tetramine. The acid can be a mineral acid or a carboxylic acid. The acid may consist of, but is not limited to, HCl, H₂SO₄, H₃PO₄, HNO₃, acetic acid, propionic acid, trifluoroacetic acid, formic acid, oxalic acid, or any other acid capable of donating a proton to the parent amine.

Partial neutralization of the amine portion of a Formulae I˜V composition as used herein is accomplished by contacting the selected amine with a selected acid in an amount such that the ratio of moles of acid per mole of amine in a Formulae I˜IV composition is greater than about 0.1, or greater than about 0.2, or greater than about 0.3, or greater than about 0.4, and yet is less than about 0.7, or less than about 0.8, or less than about 0.9, or less than about 1.0. For a Formula V composition, the ratio of moles of acid per mole of amine is greater than about 0.2, or greater than about 0.4, or greater than about 0.6, or greater than about 0.8, and yet is less than about 1.4, or less than about 1.6, or less than about 1.8, or less than about 2.0.

The netralizaton reaction is typically run at a temperature that is greater than about 20° C., or greater than about 30° C., or greater than about 40° C., and yet is less than about 70° C., or less than about 80° C., or less than about 90° C. Temperature control can be achieved by slow addition of the acid to the base, dilution of either or both with water, and/or running in an ice or other chilled bath.

Without wishing to be bound by theory, for the structures described herein, it is believed that the carbon dioxide reacts with the partially protonated amine to form a carbamate similar in structure to a typical aliphatic amine. However, for the specific amino structures proposed having vicinal amino groups, that is having amino substitution on adjacent carbon atoms, results in a dramatic reduction of the pKa of the vicinal amino group after protonation of the first amino group. Thus the unprotonated amino group becomes a much weaker base and nucleophile. It is proposed that the effect of CO₂ and/or SO₂ binding to a more weakly basic amine as well as unspecified steric and entropic effects, will allow a more readily reversible carbamate adduct. Therefore, the CO₂ and/or SO₂ binding should be reversible under milder conditions than with the unprotonated amine or other monoamines proposed in the literature. These milder conditions may be a smaller increase in temperature, a smaller reduction in the partial pressure of CO₂ and/or SO₂ or a smaller change in pH.

The method optionally involves an additional step of recovering a reaction product (such as a compound or an adduct) formed between CO₂ and/or SO₂ and a Formula I compound; and also involves yet another optional step of separating CO₂ and/or SO₂ from the Formula I compound, and recovering either or both of CO₂ and/or SO₂ and the Formula I compound. Separation can be effected by heating or the use of a non-solvent. CO₂ and/or SO₂ can thereby be removed from the mixture.

The compositions described herein are thus useful for separation methods such as CO₂ and/or SO₂ absorption, adsorption, or other types of recovery. This can be accomplished by contacting a gaseous mixture containing CO₂ and/or SO₂ with one or more of the compositions represented by the structures of Formula I, Formula II, Formula III, Formula IV or Formula V as defined above. The compositions defined above may be used without dilution or with dilution as an aqueous or other solution.

The gaseous mixture containing CO₂ and/or SO₂ can be any mixture of which CO₂ and/or SO₂ is a constituent part, or can be 100% CO₂ and/or SO₂. Examples of gaseous mixtures containing CO₂ and/or SO₂ include without limitation flue gases, combustion exhausts, natural gas streams, streams from rebreathing apparatus, and the products of chemical synthesis, degradation or fermentation operations. The gases and gaseous mixtures referred to herein may include vapors (volatilized liquids), gaseous compounds and/or other gaseous elements.

Contacting the compositions of Formula I, Formula II, Formula III, Formula IV or Formula V as described or in solution with a gaseous mixture containing CO₂ and/or SO₂ may be accomplished by any means that promotes intimate mixing of the compositions with the source gas and is conducted for a time sufficient to allow significant removal of the targeted component(s). Thus, systems maximizing surface area contact are desirable. The conditions at which the process are conducted vary according to the compositions of the gaseous stream, the partial pressure of the CO₂, and/or SO₂ and equipment used, but in suitable embodiments be at temperatures ranging from ambient to about 200° C., and at pressures ranging from 1-5 atmospheres.

Illustratively, contacting the compositions of Formula I, Formula II, Formula III, Formula IV or Formula V as described or in solution with a gaseous mixture can be performed by use of conventional liquid absorbers, such as counter-current liquid absorbers or cyclone scrubbers, by permeation through a supported liquid membrane, or by use of a fixed bed.

In one embodiment hereof, a liquid solvent can be used to remove a composition from a gas stream in an absorber, where gas and liquid are brought into contact countercurrently, and the gas is dissolved into the solvent. The absorber is typically equipped with trays or packing to provide a large liquid-gas contact area. Valve and sieve trays may be used, as may bubble cap and tunnel trays, where a tray typically has overflow weirs and downcomers to create hydrostatic holdup of the downward flow of the liquid. Random packings can also be used such as Rashig rings, Pall rings or Berl saddles, or structured packings of woven or nonwoven fabrics of metal, synthetic materials or ceramics.

The purified gas is taken off the head of the column. The solvent laden with the absorbed composition is withdrawn from the bottom of the absorber, routed to a regeneration system where it is freed of absorbed the absorbed gas component, and returned as lean solvent to the absorber. Regeneration may be accomplished by flash regeneration, which can involve pressure reduction and mild reboiling in one or more stages; by inert gas stripping; or by high temperature reboiling wherein the solvent is stripped by its own vapor, which is then condensed from the overhead gas and recycled as reflux.

In an absorber, a batch process may be performed where the flow rate through the vessel correlates to the residence time of contact and is suitably chosen to afford an effluent stream with the desired purification tolerance. To promote the desired intimate mixing, such gas/liquid absorption units also may be operated in a dual flow mode. Such dual flow can be co-current or counter-current. In such an embodiment, the gas mixture and the compositions of Formula I or Formula II flow through a purification unit contemporaneously. Methods for carbon dioxide absorption are further discussed in U.S. Pat. No. 6,579,343; US 2005/0129598; and US 2008/0236390 (each of which is by this reference incorporated as a part hereof for all purposes).

Where supported liquid membranes are used for gas recovery, the membrane may include a solvent such as the compositions of Formula I, Formula II, Formula III, Formula IV or Formula V contained within the pores of a solid microporous support, such as a ceramic, metal, or polymeric support. Supported liquid membranes fabricated from supports such as ceramics, metals, and certain heat stable polymers may advantageously be used in higher than ambient temperature operations. Such higher temperature operations may be preferred to effect a more rapid separation, requiring less contact time. In addition, these higher temperature operations may also be a consequence of the process configuration, such as configurations requiring purification of high temperature exhaust gases or other gases exiting high temperature operations. Supported liquid membranes suitable for purifying high temperature gases obviate the need to pre-cool such gases before contact with the supported liquid membrane. The supported liquid membranes may be fabricated as thin films or hollow fibers with continuous networks of interconnected pores leading from one surface to the other. Supported liquid membranes contact a feed gas mixture on one side of the membrane and may effect separation of a gas component from the mixture by allowing that component to escape via permeation or diffusion into the compositions of Formula I, Formula II, Formula III, Formula IV or Formula V and through the liquid membrane.

The compositions of Formula I, Formula II, Formula III, Formula IV or Formula V can also be used in a conventional gas/liquid absorption unit-based system comprising a fixed bed. Such systems can be operated in batch mode or continuous flow mode. In a typical batch mode configuration, the compositions of Formula I, Formula II, Formula III, Formula IV or Formula V are introduced into a vessel followed by introduction of the gas mixture. After a prescribed residence time, the resulting gas is removed, leaving behind an impurity or group of impurities dissolved in the compositions of Formula I, Formula II, Formula III, Formula IV or Formula V. The batch purified gas can be generated by heating or reduced pressure treatment as described above. To maximize contact of the composition and the gas mixture, the compositions of Formula I, Formula II, Formula III, Formula IV or Formula V can be coated on a solid support, such as glass beads, and the like, to increase the surface area capable of contacting the gas mixture.

In one embodiment, this invention provides a method wherein the removal of CO₂ and/or SO₂ from a gaseous mixture occurs in a removal apparatus; wherein, in the removal apparatus, CO₂ and/or SO₂ is dissolved into a Formula I, Formula II, Formula III, Formula IV or Formula V composition(s) to form (i) a purified fraction that is depleted in CO₂ and/or SO₂ content (compared to the content thereof in the original feed of the gaseous mixture) and (ii) a solvent fraction that is enriched in CO₂ and/or SO₂ content (compared to the content thereof in the original feed of the gaseous mixture); and wherein the solvent fraction is separated from the removal apparatus. In a further alternative embodiment of the methods hereof, CO₂ and/or SO₂ can be separated from the solvent fraction to form a rectified solvent fraction, and the rectified solvent fraction can be returned to the removal apparatus.

Equipment and processes that can be used for the absorption of CO₂ and/or SO₂ are further described in Absorption, Ullmann's Encyclopedia of Industrial Chemistry [2002, (Wiley-VCH Verlag GmbH & Co. KGa) Johann Schlauer and Manfred Kriebel, Jun. 15, 2000 (DOI: 10.1002/14356007.b03_{—}08)]; and Absorption, Kirk-Othmer Encyclopedia of Chemical Technology [2003, (John Wiley & Sons, Inc), Manuel Laso and Urs von Stockar (DOL10.1002/0471238961.0102191519201503.a01.pub2)].

### EXAMPLES

The operation and effects of certain embodiments of the inventions hereof may be more fully appreciated from a series of examples, as described below. The embodiments on which these examples are based are representative only, and the selection of those embodiments to illustrate the invention does not indicate that materials, reactants, protocols or conditions not described in the examples are not suitable for use herein, or that subject matter not described in the examples is excluded from the scope of the appended claims and equivalents thereof.

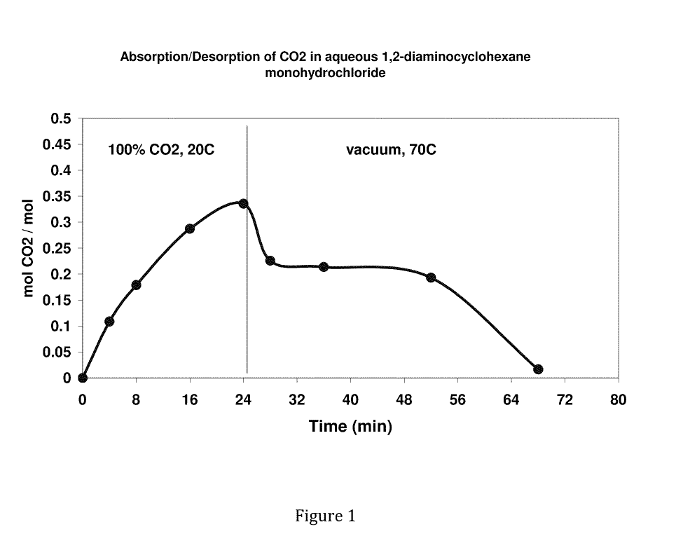

I. Diaminocyclohexane: A 40 mL glass vial with a cap fitted with a silicone septum and containing about 3 grams of a 30% aqueous solution of 1,2-diaminocyclohexane monohydrochloride at 20° C. was subjected to a stream of CO₂ at 1 atm over a 24 minute period. Subsequently, the vial was heated to 70° C. under a slight vacuum for an additional time. Weighings of the vial were taken at periodic intervals to monitor the uptake and release of CO₂ from solution. The results are plotted in FIG. 1.

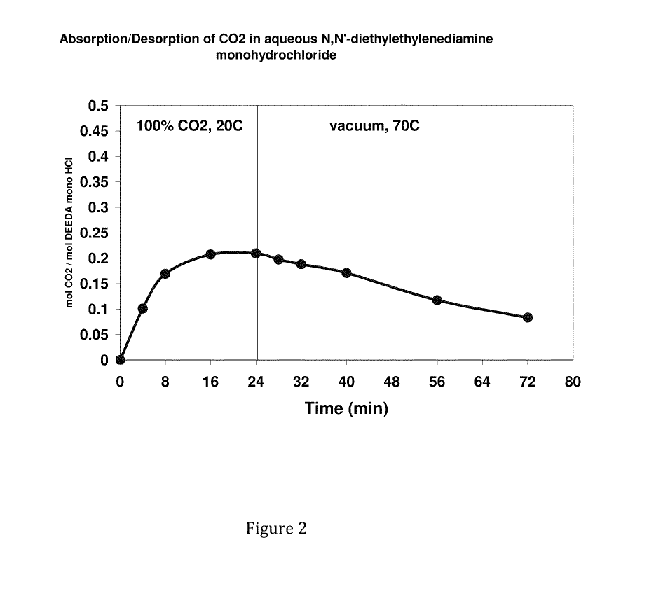

II. Diethylethylenediamine: A 40 mL glass vial with a cap fitted with a silicone septum and containing about 3 grams of a 30% aqueous solution of N,N′-diethylethylenediamine monohydrochloride at 20° C. was subjected to a stream of CO₂ at 1 atm over a 24 minute time period. Subsequently, the vial was heated to 70° C. under a slight vacuum for an additional time. Weighings of the vial were taken at periodic intervals to monitor the uptake and release of CO₂ from solution. The results are plotted in FIG. 2.

III. Absorption of CO₂ by amino compounds represented by Formula I, Formula II, Formula III, Formula IV or Formula V. Duplicates of a 0.2 to 0.5 g sample of a compound or an aqueous solution were placed in screw cap, 6 ml autosampler vials having silicone septa. A 49-station tray (a 7×7 array) holding the vials was placed under an array of needles. Each needle was positioned over a vial and connected to a common manifold that allowed the flow of CO₂ gas through the needle plenum. The needle array was pneumatically lowered so that the needles penetrated the vial septa and exposed each compound to a headspace containing nitrogen at 40° C. The apparatus is designed so that the headspace is under positive pressure to allow a continuously flow of 20 mL/minute through each vial. Periodically, the gas flow was stopped; the samples were removed from the tray and weighed. The samples were maintained under an atmosphere of nitrogen until reaching a constant weight. The samples were then replaced in the tray, the needle array lowered and exposed similarly to a CO₂ atmosphere at 30° C. until the CO₂ uptake reached equilibrium as measured by a maximum weight gain. The results are presented in the following table (Table I) as gCO₂ absorbed/g sample and as the deviation between duplicate samples:

TABLE I

| | Anion | | |
|---|---|---|---|
| | from | gCO₂/g | |
| Amine Compound | HX | Compound | Deviation |
| 1,2-Diaminopropane | chloride | 0.049 | 0.0003 |
| N,N-Diethyl ethylenediamine | chloride | 0.045 | 0.0007 |
| 2-(Diisopropylamino) ethylamine | chloride | 0.048 | 0.0003 |
| N,N′-Dimethyl ethylenediamine | chloride | 0.055 | 0.0003 |
| N,N′-Diethyl ethylenediamine | chloride | 0.051 | 0.0002 |
| N,N′-Diisopropyl ethylenediamine | chloride | 0.034 | 0.0016 |
| N-Propyl ethylenediamine | chloride | 0.050 | 0.0011 |
| N-Butyl ethylenediamine | chloride | 0.044 | 0.0005 |
| N,N-Dimethyl-N′-ethyl | chloride | 0.043 | 0.0000 |
| ethylenediamine | | | |
| 1,2-Diaminocyclohexane | chloride | 0.049 | 0.0004 |
| Diethylenetriamine | chloride | 0.086 | 0.0006 |
| N-(2-Aminoethyl)-1,3- | chloride | 0.095 | 0.0021 |
| propanediamine | | | |
| N1-Isopropyl diethylenetriamine | chloride | 0.079 | 0.0014 |
| Triethylenetetramine | chloride | 0.130 | 0.0013 |
| Tris(2-aminoethyl) amine | chloride | 0.108 | 0.0005 |
| Piperazine | chloride | 0.027 | 0.0023 |
| 1-(2-Aminoethyl) piperazine | chloride | 0.060 | 0.0007 |
| N,N,N′,N′-Tetramethyldiamino | chloride | 0.086 | 0.0014 |
| methane | | | |
| 1,2-Diaminopropane | acetate | 0.116 | 0.0153 |
| 1,2-Diaminocyclohexane | acetate | 0.087 | 0.0138 |
| N,N-Dimethylethylenediamine | acetate | 0.114 | 0.0007 |
| N,N-Diethylethylenediamine | acetate | 0.109 | 0.0072 |
| 2-(Diisopropylamino)ethylamine | acetate | 0.094 | 0.0164 |
| N,N′-Dimethylethylenediamine | acetate | 0.127 | 0.0182 |
| N,N,N′-Trimethylethylenediamine | acetate | 0.086 | 0.0250 |
| 3-(Dimethylamino)-1-propylamine | acetate | 0.109 | 0.0174 |
| Diethylenetriamine | acetate | 0.135 | 0.0164 |
| 1-(2-Aminoethyl)piperazine | acetate | 0.087 | 0.0263 |
| Triethylenetetramine | acetate | 0.156 | 0.0390 |
| Tris(2-aminoethyl)amine | acetate | 0.112 | 0.0211 |
| 1-(2-Aminoethyl)piperidine | acetate | 0.088 | 0.0235 |
| 4-(2-Aminoethyl)morpholine | acetate | 0.037 | 0.0683 |
| N-(2- | acetate | 0.091 | 0.0291 |
| Hydroxyethyl)ethylenediamine | | | |
| N,N-Diethylethylenetriamine | acetate | 0.144 | 0.0508 |
| 1,2-Diaminopropane | phosphate | 0.140 | 0.0016 |
| N,N-Dimethylethylenediamine | phosphate | 0.135 | 0.0001 |
| N,N-Diethylethylenediamine | phosphate | 0.190 | 0.0037 |
| N,N-Diisopropylethylenediamine | phosphate | 0.121 | 0.0005 |
| N,N′-Dimethylethylenediamine | phosphate | 0.135 | 0.0009 |
| N-Propylethylenediamine | phosphate | 0.121 | 0.0009 |
| N,N,N′-Trimethylethylenediamine | phosphate | 0.111 | 0.0010 |
| N,N-Dimethyl-N′- | phosphate | 0.117 | 0.0001 |
| ethylethylenediamine | | | |
| 1,2-Diaminocyclohexane | phosphate | 0.067 | 0.0038 |
| N,N-Diethylethylenetriamine | phosphate | 0.152 | 0.0059 |
| 1-(2-aminoethyl)-pyrrolidine | phosphate | 0.122 | 0.0002 |
| 1-(2-Aminoethyl)piperidine | phosphate | 0.110 | 0.0005 |
| N-(2- | phosphate | 0.123 | 0.0027 |
| Hydroxyethyl)ethylenediamine | | | |

Various materials suitable for use herein may be made by processes known in the art, and/or are available commercially from suppliers such as Alfa Aesar (Ward Hill, Mass.), City Chemical (West Haven, Conn.), Fisher Scientific (Fairlawn, N.J.), Sigma-Aldrich (St. Louis, Mo.) or Stanford Materials (Aliso Viejo, Calif.).

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

Each of the formulae shown herein describes each and all of the separate, individual compounds and compositions that can be assembled in that formula by (1) selection from within the prescribed range for one of the variable radicals, substituents or numerical coefficents while all of the other variable radicals, substituents or numerical coefficents are held constant, and (2) performing in turn the same selection from within the prescribed range for each of the other variable radicals, substituents or numerical coefficents with the others being held constant. In addition to a selection made within the prescribed range for any of the variable radicals, substituents or numerical coefficents of only one of the members of the group described by the range, a plurality of compounds and compositions may be described by selecting more than one but less than all of the members of the whole group of radicals, substituents or numerical coefficents. When the selection made within the prescribed range for any of the variable radicals, substituents or numerical coefficents is a subgroup containing (i) only one of the members of the whole group described by the range, or (ii) more than one but less than all of the members of the whole group, the selected member(s) are selected by omitting those member(s) of the whole group that are not selected to form the subgroup. The compound, composition or plurality of compounds or compositions, may in such event be characterized by a definition of one or more of the variable radicals, substituents or numerical coefficents that refers to the whole group of the prescribed range for that variable but where the member(s) omitted to form the subgroup are absent from the whole group.

Other related systems, materials and methods for the removal of CO₂ or SO₂ from a gaseous mixture are disclosed in the following concurrently-filed U.S. provisional patent applications:

61/313,298, 61/414,532, 61/416,421; 61/313,173;
61/313,181; 61/313,322; 61/313,328;
61/313,312; 61/313,183; and 61/313,191;

each of which is by this reference incorporated in its entirety as a part hereof for all purposes.

What is claimed is:

1. A method for the removal of CO₂ and/or SO₂ from a gaseous mixture comprising contacting the gaseous mixture with one or more compounds represented by the structure of Formula I, Formula II, Formula III, Formula IV or Formula V: 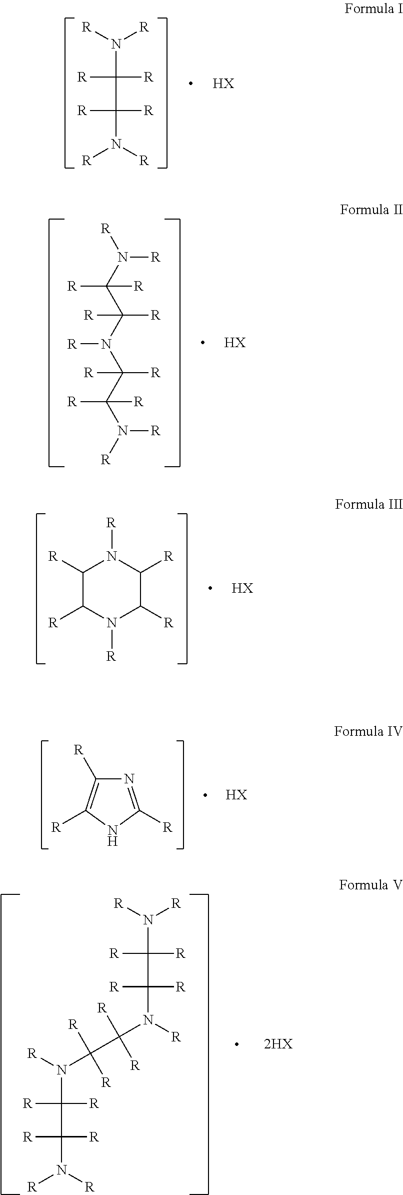
wherein each R is independently H, alkyl, hydroxyalkyl, aminoalkyl, alkylaminoalkyl or alkoxyalkyl, wherein the alkyl groups contain 1-6 carbons, and each R together can form one or more alicyclic rings with any one or more R;
HX is an acid with an acidic proton that forms a partially neutralized salt of the amine; and
optionally, removing CO₂ and/or SO₂ from the mixture.

2. The method of claim 1 wherein Formula I is 1,2-diaminocyclohexane, Formula II is diethylenetriamine, Formula III is 1-methylpiperazine, Formula IV is 4,5-dimethylimidazole and Formula V is N,N,N′,N′-tetramethyltriethylenetetramine

3. The method of claim 1 wherein the removal of one or more of CO₂ and SO₂ from the gaseous mixture occurs in a removal apparatus; wherein, in the removal apparatus, one or more of CO₂ and SO₂ is dissolved into a compound of Formula I, Formula II, Formula III, Formula IV or Formula V to form (i) a purified fraction that is depleted in one or more of CO₂ and SO₂ content and (ii) a solvent fraction that is enriched in one or more of CO₂ and SO₂ content; and wherein the solvent fraction is separated from the removal apparatus.

4. The method of claim 3 wherein one or more of CO₂ and SO₂ is separated from the solvent fraction to form a rectified solvent fraction, and the rectified solvent fraction is returned to the removal apparatus.
